(19) United States
(12) Patent Application Publication
(10) Pub. No.: US 2018/0333764 A1
(43) Pub. Date: Nov. 22, 2018

(54) PRODUCTION PLANT FOR MANUFACTURING REINFORCEMENT ELEMENTS

(71) Applicant: Hubert RAPPERSTORFER, Steinhaus bei Wels (AT)

(72) Inventor: Hubert RAPPERSTORFER, Steinhaus bei Wels (AT)

(21) Appl. No.: 15/769,365

(22) PCT Filed: Oct. 14, 2016
(86) PCT No.: PCT/EP2016/074754

§ 371 Date: Jul. 2, 2018

(30) Foreign Application Priority Data
Oct. 21, 2015 (AT) A 50900/2015

(51) Int. Cl. B21F 27/20; B21F 27/10; B25J 9/16; E04C 5/06

(52) U.S. Cl. CPC B21F 27/20; B21F 27/10; E04C 5/0609; B25J 9/1687; B25J 9/1682

(57) ABSTRACT

The invention relates to a production plant (18) for manufacturing a three-dimensional reinforcement element for a reinforced concrete element, comprising a receiving table (19) for accommodating the reinforcement element and a manipulation device (21) for manipulating and joining individual parts of the reinforcement element. The manipulation device (21) comprises a first articulated arm robot (22) having a gripping mechanism (24) for positioning rebar mats and/or spacers of the reinforcement element and a second articulated arm robot (23) a welding unit (25) for welding the spacers to the rebar mats.

The invention relates to a production plant for manufacturing a three-dimensional reinforcement element for a reinforced concrete element and a method for manufacturing the three-dimensional reinforcement element on the production plant.

A device for manufacturing three-dimensional wire structures is known from U.S. Pat. No. 4,667,707. This device has a complex design and is not very flexible when it comes to manufacturing different wire structures.

The present invention seeks to create a device for manufacturing a reinforcement element that can be used flexibly to manufacture different reinforcement elements and a method of operating such a device.

This aim of the invention is achieved by the device in claim 1 and the method in claim 15.

The invention relates to a production plant for manufacturing a three-dimensional reinforcement element, comprising a receiving table for accommodating the reinforcement element and a manipulation device for manipulating and joining individual parts of the reinforcement element. The manipulation device comprises a first articulated arm robot having a gripping mechanism for positioning rebar mats and/or spacers of the reinforcement element and a welding unit for substance welding the spacers to the rebar mats.

The advantage of the invented form of the production plant is that the arrangement of the articulated arm robots allows the flexibility of the production plant to be increased compared to known and conventional production plants. Therefore differently designed reinforcement elements can be manufactured on this automatable production plant. This high flexibility can only be reached by the combination of the first articulated arm robot with the gripping mechanism and the second articulated arm device with the welding unit on a common manipulation device.

It can further be provided for the welding unit to be arranged on a second articulated arm robot. The advantage here is that the flexibility of the production plant can be increased in this way.

It can further be useful if the first and the second articulated arm robots are each arranged on a common linear guide device by a guide unit and are therefore displaceable in the longitudinal direction of the receiving table relative to each other and relative to the receiving table. The advantage here is that the two articulated arm robots can have greater flexibility and therefore reinforcement elements with longer longitudinal extension can be manufactured by the two articulated arm robots. The realisation of a common linear guide device is of course also possible with the third and fourth articulated arm robots.

In particular, it can be provided for the linear guide device to be arranged next to the receiving table. It is conceivable here for the linear guide device to be coupled to the receiving table by a machine frame. In an alternative variation, it is also conceivable for the linear guide device and the receiving table to each be attached separately and independently of each other to the substratum. For example, compared to a portal, a linear guide device arranged next to the receiving table has the advantage that the table surface of the receiving table is freely accessible. Thus the individual reinforcement elements can be positioned on the receiving table by the lifting unit.

Alternatively, it can be provided for the first and second articulated arm robots to be executed as dual arm robots and share a common base unit. The advantage here is that a dual arm robot having a common base unit is more simply designed than two independently displaceable robots. This allows the acquisition costs of such a dual arm robot to be kept low, increasing the profitability of the production plant.

It can further be provided for a second manipulation device to be formed that comprises a third articulated arm robot with a gripping mechanism for positioning rebar mats and/or spacers of the reinforcement element and a fourth articulated arm robot with a welding unit for substance welding of the spacers to the rebar mats, where the second manipulation device is arranged on the side of the receiving table across from the first manipulation device. The advantage here is that the flexibility and processing speed of the production plant can be increased by the second manipulation device. In particular, both manipulation devices can be used for simultaneous processing of the reinforcement element.

Also advantageous is a form in which it can be provided that at least one of the articulated arm robots has a coupling device in order to be able to receive variously shaped gripping mechanisms and/or welding units. The advantage here is that, for example, multiple different gripping mechanisms and/or welding units can be formed for different spacers, where these different gripping mechanisms and/or welding units can optionally be attached to the different articulated arm robots.

In a further development, it is possible for the welding unit to be formed as a resistance welding unit. A resistance welding unit is particularly good for welding a great variety of rod-shaped elements. In addition, in a resistance welding unit the required welding time can be kept low, increasing the profitability of the production plant.

It can further be expedient for a lifting unit, in particular a crane, to be formed to manipulate the individual parts and/or the whole reinforcement element. The crane can easily and efficiently manipulate the reinforcement element, which has a high mass. In particular, the reinforcement element can be passed on to another processing plant such as a concreting plant to manufacture a double wall.

In addition, it can be provided for a preparation device for cutting to length and preparing the spacers and/or rebar mats to be formed. The advantage here is that the spacers can be cut to length directly on the production plant, increasing the flexibility of the production plant.

It can further be provided for at least one conveying unit to be arranged on a long side of the receiving table, with the conveying unit formed to convey spacers to the articulated arm robots. The conveying unit can bring the spacers to the articulated arm robots. This can minimise the processing time, as the articulated arm robots with the gripping head need only travel short routes.

In a special form, it is possible for the conveying unit to be designed in the form of a circumferential carrying unit, in particular a chain, where the carrying unit comprises multiple carrying elements that can each receive a spacer. Such a circumferential carrying unit can receive many spacers; the spacers can always be placed on the carrying unit or removed from it again.

An advantageous further development provides for a manipulation unit, in particular an articulated arm robot, to be arranged at the front of the receiving table and designed to load the conveying unit with spacers. It is advantageous for such an articulated arm robot to be able to be used, for example, to load two conveying units. In addition, an articulated arm robot can have high flexibility to be able to receive a variety of spacers.

In particular, it can be advantageous for the gripping mechanism to comprise a gripping head that has a first and a second gripping finger, where the two gripping fingers each have a V-shaped groove on the side facing each other and where both gripping fingers each have mirror-inverted recesses and therefore interlock with each other. The V-shaped groove and the mirror-inverted recesses of the gripping fingers make it possible for spacers with different diameters to be advantageously gripped using the gripping fingers, with the V-shaped groove of the gripping fingers making it possible for the spacers to be held in a centred and correctly oriented way in the gripping mechanism.

It can further be provided for an injection moulding device to be formed at the front of the receiving table that is used to mould a protective cap onto at least one end section of the rod-shaped spacer. The advantage here is that the injection moulding device can furnish the previously cut-to-length spacers with protective caps, with the protective caps being moulded directly onto the spacers and having a high strength.

It can further be provided for a rod magazine to be formed on which the rod-shaped spacers can be temporarily stored.

It can additionally be provided for the underlay element to have one or more manipulation pegs.

It can further be useful if lifting anchors are arranged on the reinforcement element that receive the reinforcement element. For example, the lifting anchors can be positioned on the rod-shaped spacers.

Also provided is a method for manufacturing a three-dimensional reinforcement element, with the method comprising the following steps:
Preparation of a first rebar mat with metallic mat rods welded together at angles at junction points, with the first rebar mat positioned on a receiving table and held by it;
Preparation and positioning of rod-shaped spacers across from the mat rods of the first rebar mat using a gripping mechanism of a first articulated arm robot;
Welding of the spacers to the mat rods of the first rebar mat using a welding unit arranged on a second articulated arm robot, with the mat rods held in position during the welding process by the gripping mechanism of the first articulated arm robot;
Preparation and positioning of a second rebar mat at a normal distance from the first rebar mat, in particular using the gripping mechanism of the first articulated arm robot;
Welding of the spacers to the mat rods of the second rebar mat using the welding unit arranged on the second articulated arm robot.

The advantage of the method is that the individual steps allow three-dimensional reinforcement elements with a high stability and/or strength to be manufactured out of rebar mats and spacers. In addition, the three-dimensional reinforcement elements can be designed in a variety of ways and manufactured by the production plant and the method steps with a high degree of automation. In particular, the production plant and method can increase flexibility in manufacturing reinforcement elements so much that a batch size of one can be produced. In other words, every reinforcement element can be designed differently.

A further development makes it possible for the rod-shaped spacers to be cut to length in a preparation device before they are positioned in the production plant. The advantage here is that the rod-shaped spacers can be cut exactly for the required application, with spacers of different length produced just-in-time and in the required quantity. This way the stockholding of spacers can be kept as low as possible.

It can further be useful if the rod-shaped spacers are conveyed to the first articulated arm robot by a conveying unit arranged on a long side of the receiving table. The advantage here is that the articulated arm robot need only travel short distances, increasing the manufacturing speed of the reinforcement element and the profitability of the manufacturing process.

It can further be provided for the rod-shaped spacers to be conveyed to the conveying unit by a manipulation unit, in particular an articulated arm robot. The advantage here is that the conveying unit can be loaded by the articulated arm robot, allowing the most efficient possible operation of the conveying unit.

In an alternative variation, it can be provided for the rod-shaped spacers to be fed in by the gripping mechanisms of the conveying unit. In such an embodiment no additional manipulation units would be needed.

It can further be provided for the rod-shaped spacers to be furnished with protective caps on at least one end section before being positioned in the reinforcement element. The advantage here is that the protective caps cover the end sections of the spacers and both avert damage to the supporting table and prevent corrosion of a built in spacer.

In addition, it can be provided for support rods to be attached to the rod-shaped spacers positioned at a certain distance from the first rebar mat before the second rebar mat is positioned in order to create a supporting plane for the second rebar mat. The advantage here is that the second rebar mat can be held in position by the support rods, as a result of which the second rebar mat can be pre-positioned and the articulated arm robots can be used for exact positioning or for welding of the second rebar mat.

It can further be provided that the thickness of the spacers and/or the mat rods be specified before the welding of the spacers to the mat rods by the welding unit. The advantage here is that the extent of the penetration depth during the welding process can be specified. Thus a certain strength of the welding can be guaranteed.

In addition, it can be provided that the receiving table for receiving the reinforcement element be formed as a horizontally oriented orienting table for supporting the reinforcement element.

To facilitate better understanding of the invention, it will be explained in detail using the figures below.

Extremely simplified, schematic depictions show the following:

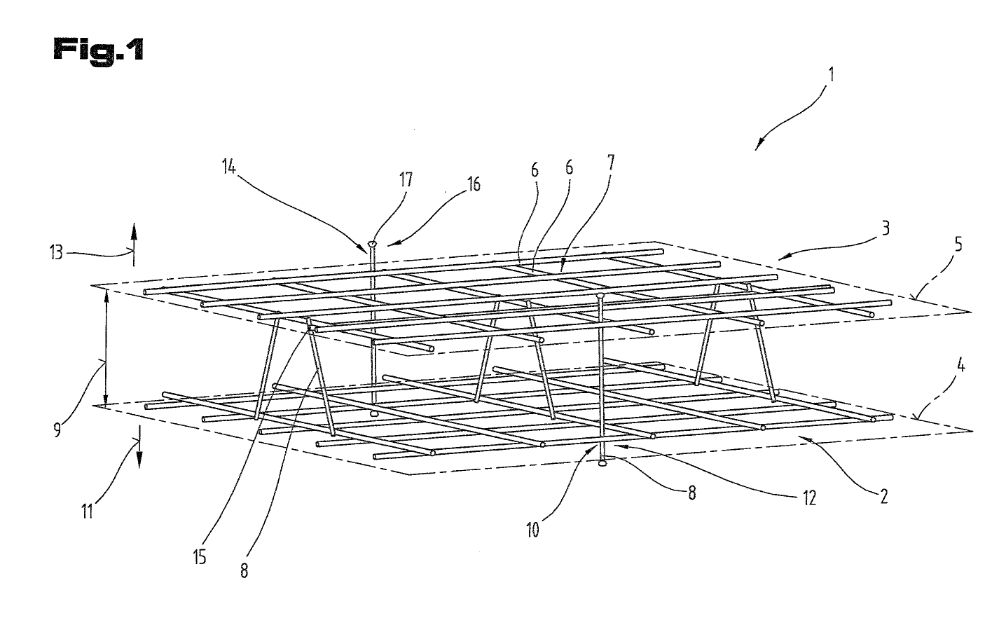

FIG. 1 A perspective view of a reinforcing element;

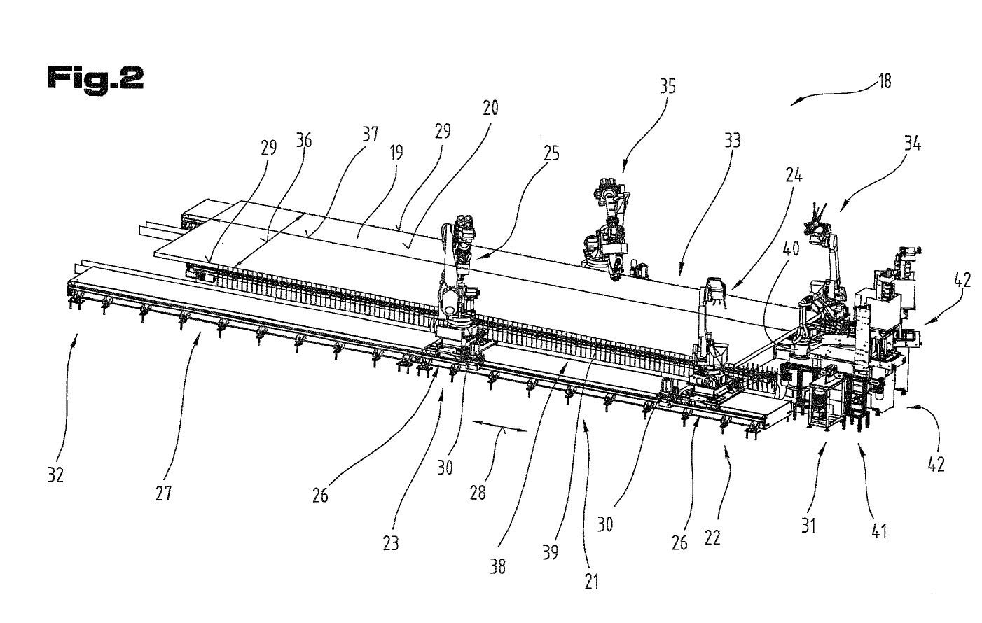

FIG. 2 A perspective view of an example embodiment of a production plant for manufacturing the reinforcement element;

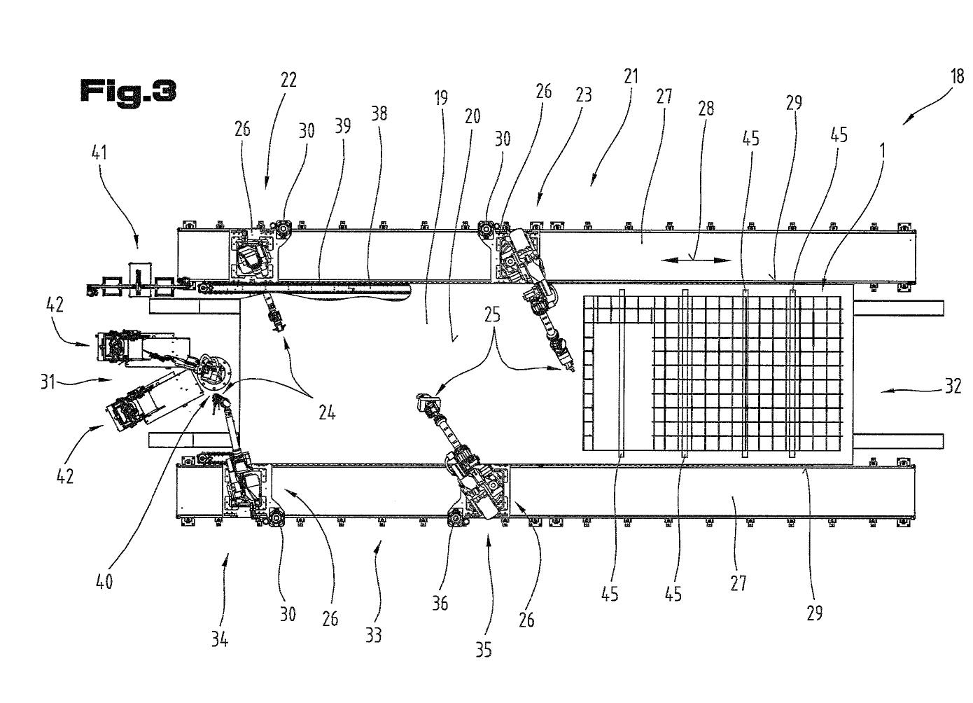

FIG. 3 A top view of an example embodiment of the production plant for manufacturing the reinforcement element;

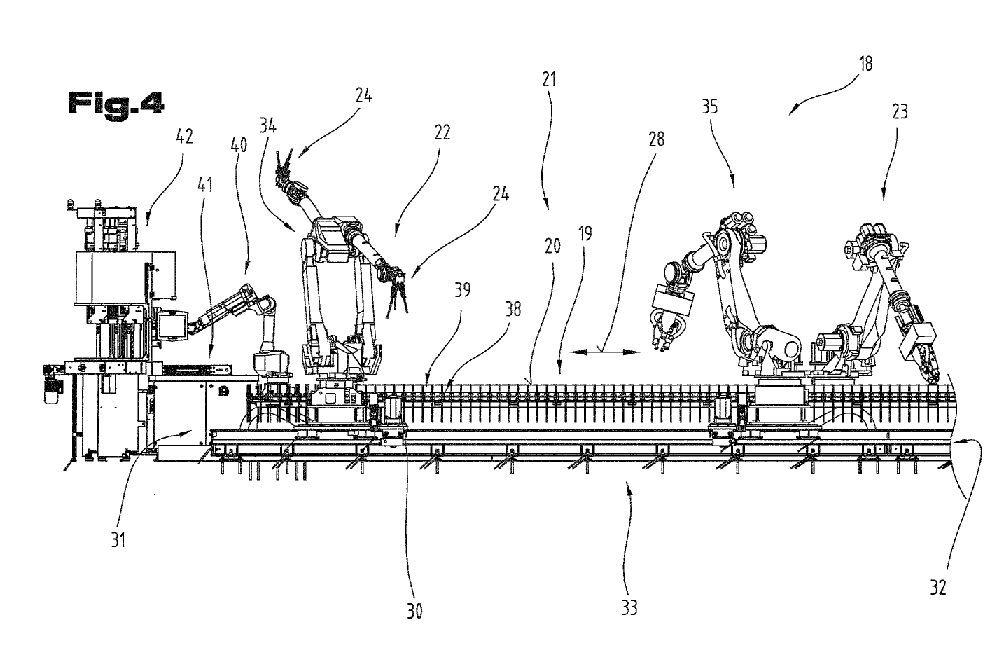

FIG. 4 A side view of an example embodiment of the production plant for manufacturing the reinforcement element;

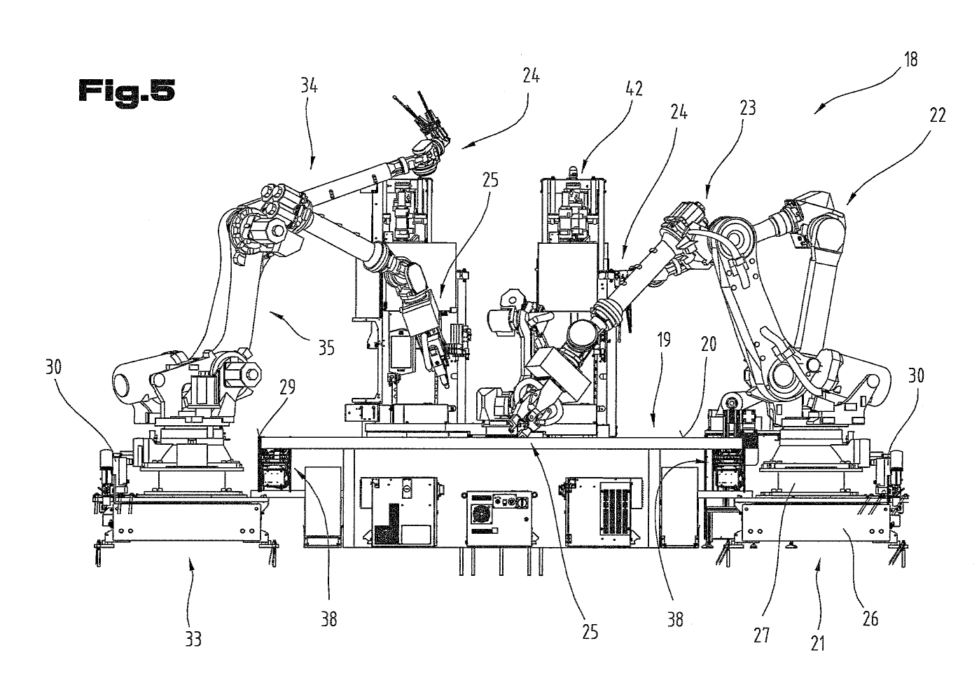

FIG. 5 A view from the front of an example embodiment of the production plant for manufacturing the reinforcement element;

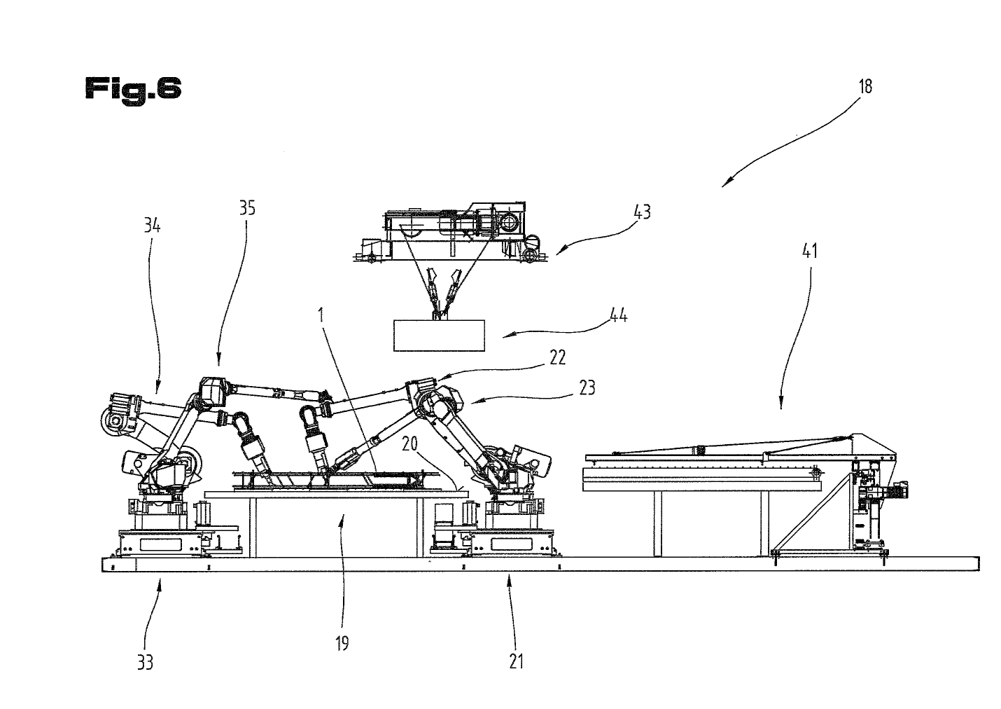

FIG. 6 A view from the front of an additional example embodiment of the production plant for manufacturing the reinforcement element;

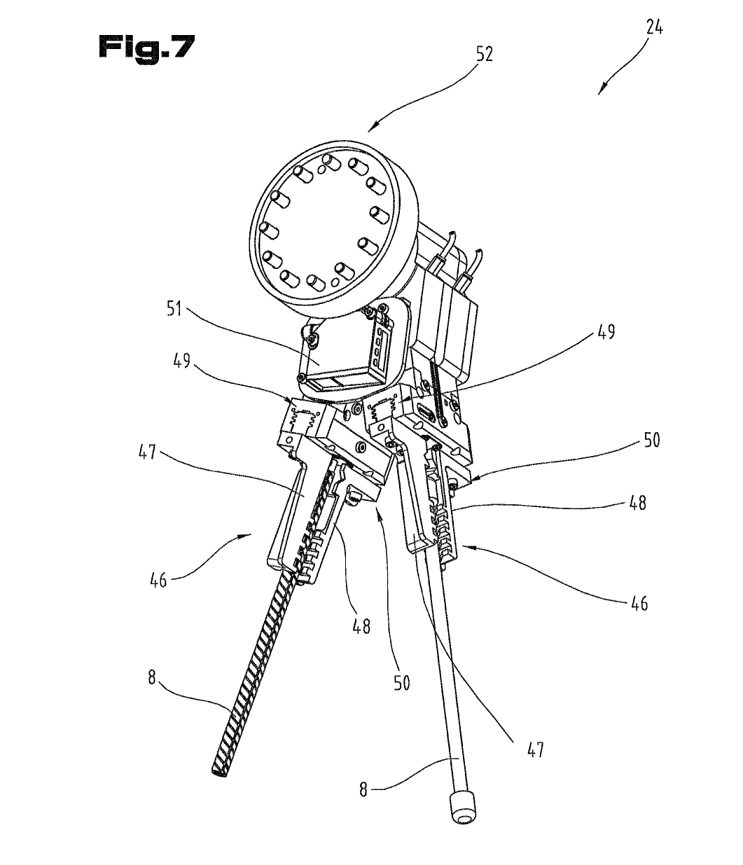

FIG. 7 A perspective view of an example embodiment of a gripping mechanism of the production plant;

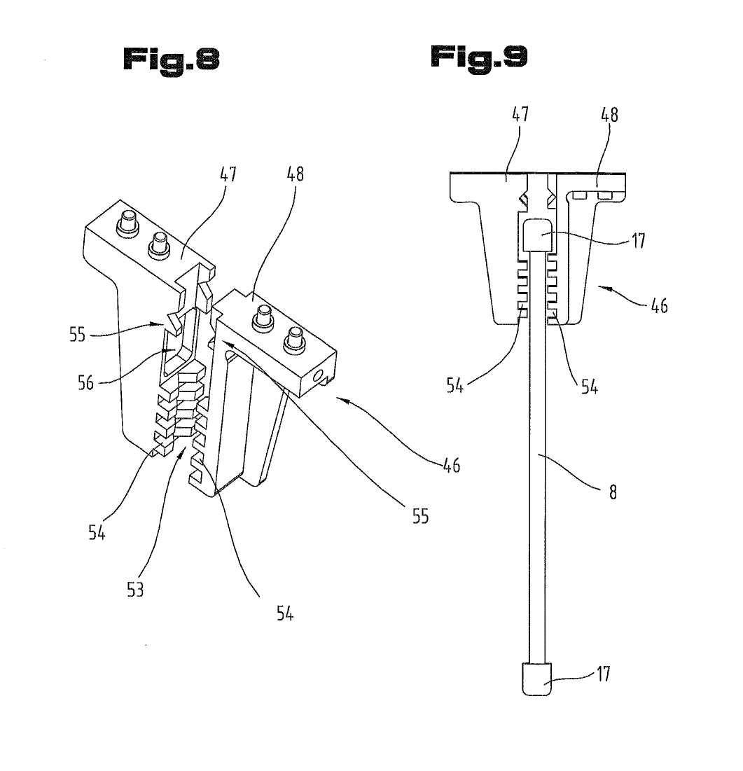

FIG. 8 A top view of an example embodiment of a gripping head of the gripping mechanism;

FIG. 9 A side view of an example embodiment of the gripping head of the gripping mechanism;

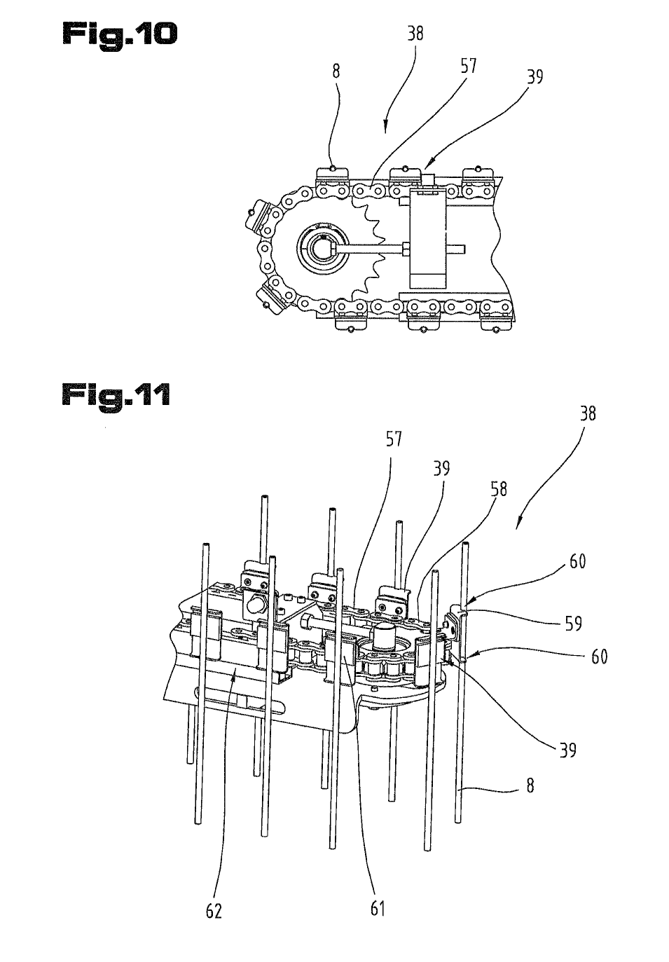

FIG. 10 A top view of an example embodiment of a conveying unit;

FIG. 11 A perspective view of an example embodiment of the conveying unit;

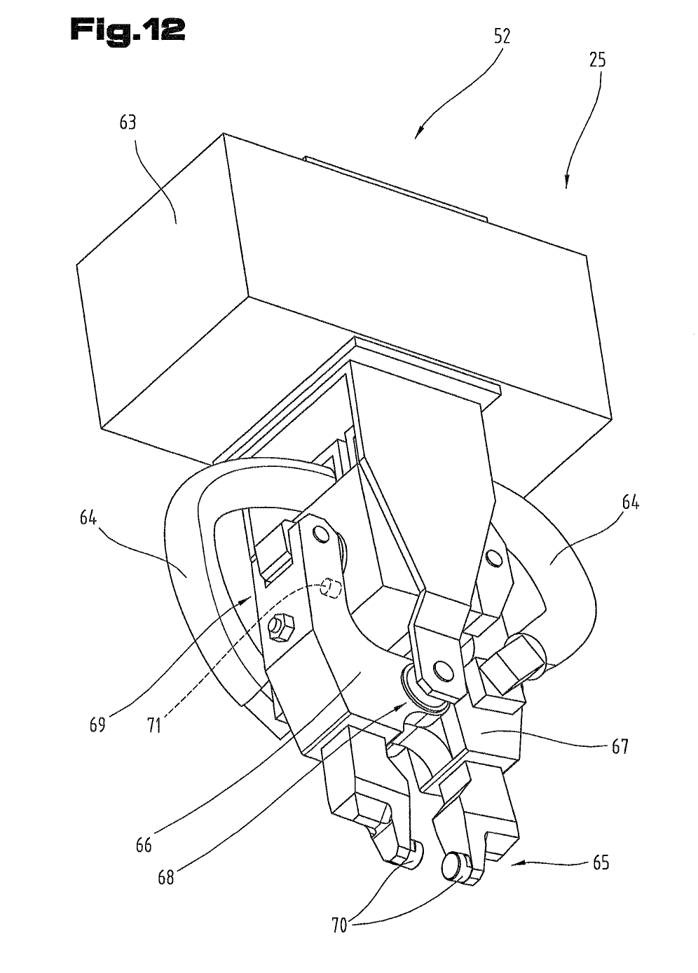

FIG. 12 A perspective view of an example embodiment of the welding unit;

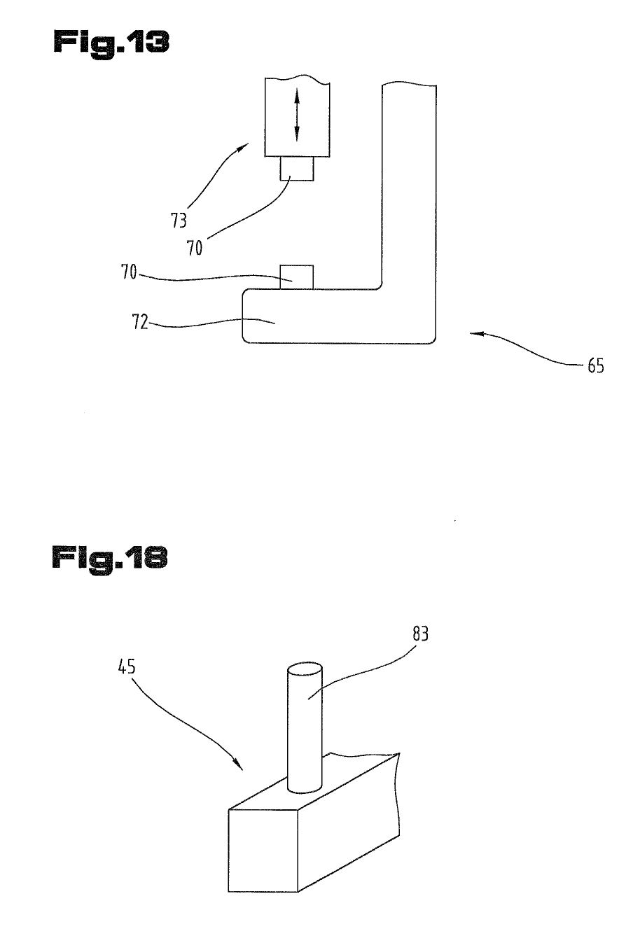

FIG. 13 A schematic illustration of an additional example embodiment of the welding unit;

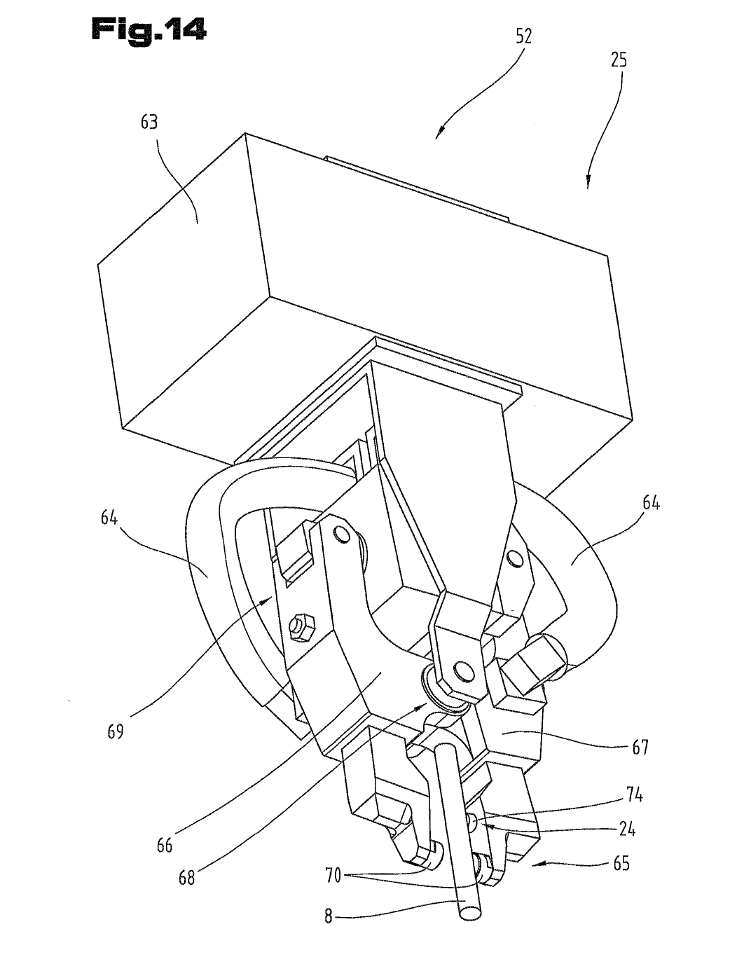

FIG. 14 A perspective view of an additional example embodiment of the welding unit;

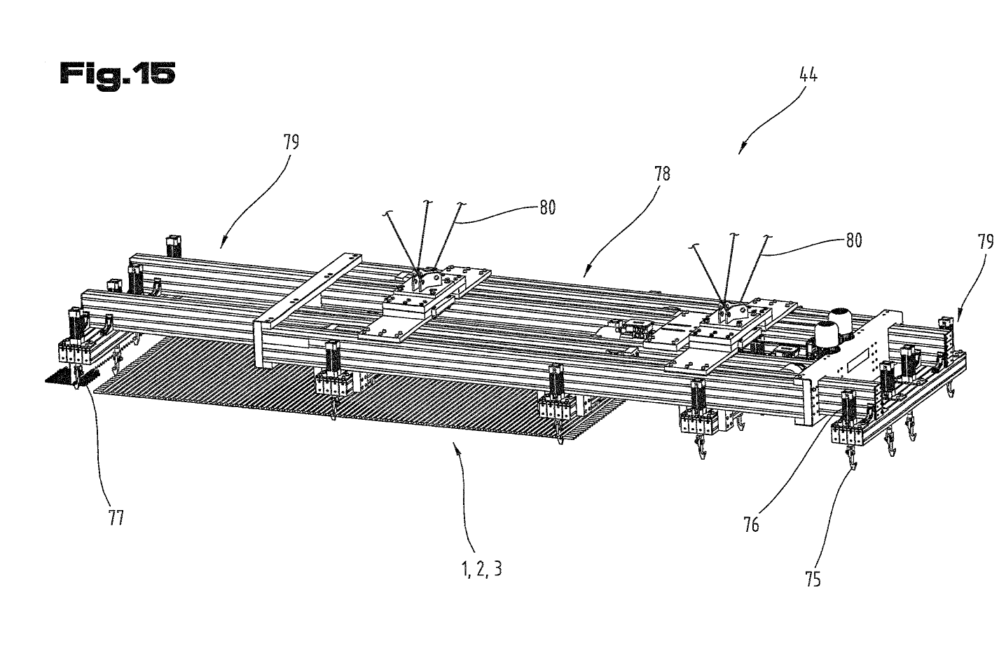

FIG. 15 A perspective view of a lifting head of a lifting unit;

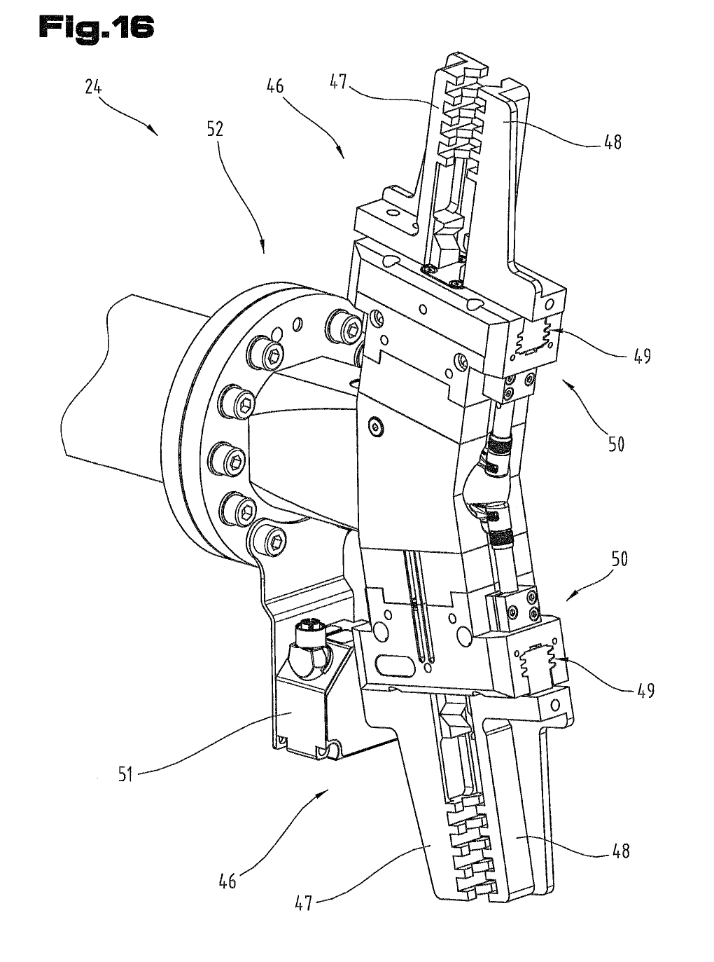

FIG. 16 A perspective view of an additional example embodiment of a gripping mechanism of the production plant;

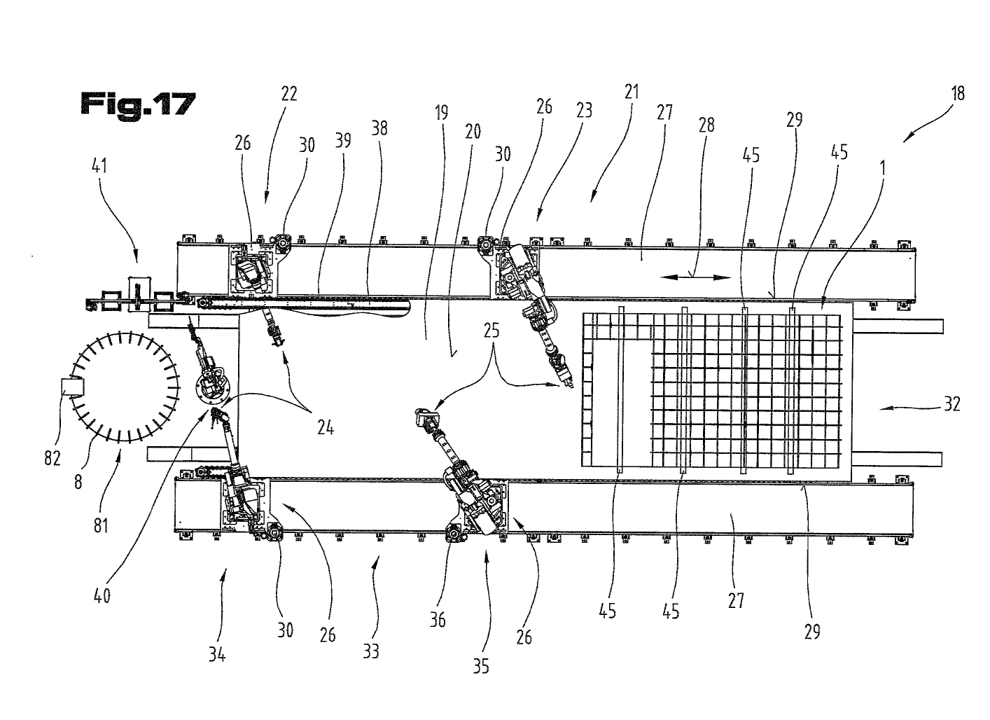

FIG. 17 A top view of an example embodiment of the production plant for manufacturing the reinforcement element with a rod magazine;

FIG. 18 A perspective view of an example embodiment of an underlay element with integrated manipulation pegs.

In introduction, let it be noted that in the variously described embodiments, identical parts are provided with identical reference signs or identical part names, and that the disclosures contained in the description as a whole can be carried over analogously to identical parts with identical reference signs or identical part names. Likewise, positional information selected in the description, e.g. above, below, on the side, etc. refer to the directly described and depicted figure and if the position is changed, this positional information carries over analogously to the new position.

FIG. 1 depicts an example of the three-dimensional reinforcement element 1 in a perspective view.

The reinforcement element 1 can be inserted in reinforced concrete construction as reinforcement or armoring. The reinforcement element 1 has a first rebar mat 2 and a second rebar mat 3, which have a first mat plane 4 and a second mat plane 5. The two mat planes 4, 5 are each defined by the outermost points of the rebar mats 2, 3.

The rebar mats 2, 3 each have multiple mat rods 6 that are configured at angles to each other. This creates a grid shape where the mat rods 6 are welded to each other at junction points 7 where they overlap. The mat rods 6 are preferably made of rcbar steel. A rebar mat 2, 3 is a grid structure of welded rods. The distance between the individual rods can be regular or irregular.

The rebar mats 2, 3 can be purchased as standardised prefabricated parts and cut to length as required on-site. In an alternative variation, it is also possible to cut the mat rods 6 to length and weld them together on-site during the manufacturing process of the reinforcement element 1.

As can be seen in FIG. 1, rod-shaped spacers 8 are provided that keep the individual reinforcing mats 2, 3 at a desired and predefined normal distance 9 from each other. The normal distance 9 is the distance at which the two mat planes 4, 5 of the rebar mats 2, 3 are placed from each other. The rod-shaped spacers 8, which are made of a metallic material, are connected to the mat rods 6 by a welding connection 10. The welding connection is preferably realised by resistance welding, especially by resistance spot welding. The advantage here is that this resistance spot welding process is easily automated and that no additional material is needed for this welding process.

However, as an alternative to resistance welding it is also possible for the spacers 8 to be connected to each other by e.g. a MAG welding process or laser welding. It is an advantage if at least three spacers 8 are provided on a reinforcement element 1. This way the reinforcement element 1 can be well-supported on the spacers 8.

It can further be provided that the spacers 8 protrude beyond the first mat plane 4 in a direction 11 pointing away from the second rebar mat 3 by a first protrusion length 12.

It can further be provided that the spacers 8 protrude beyond the second mat plane 5 in a direction 13 pointing away from the first rebar mat 2 by a second protrusion length 14.

It can further be provided for slanted spacers 8 to be arranged on the reinforcement element 1 in addition to straight spacers 8. The slanted spacers 8 preferably reach between the first mat plane 4 and the second mat plane 5. In addition, the slanted spacers 8 are preferably placed in pairs forming a V-shape, which can give the reinforcement element 1 greater stiffness. In particular, this makes it possible to create greater resistance or greater solidity against parallel displacement of the two rebar mats 2, 3 from each other. The slanted spacers 8 can preferably have a smaller diameter than the straight spacers 8. It can further be provided that the slanted spacers 8 have the same diameter as the mat rods 6.

It can further be provided that support rods 15 be arranged near the second rebar mat 3. These support rods 15 can be particularly advantageous in manufacturing the reinforcement element 1 because they can easily be connected to the spacers 8. This allows a support plane to be formed on which the second rebar mat 3 can be supported in the manufacturing process. This makes it possible for the second rebar mat 3 to already be placed almost in its final position during the manufacturing process before being welded to the spacers 8.

It can further be useful for protective caps 17 be placed on at least one end section 16 of the spacers 8 which protect the spacers 8 against corrosion and act as a support element during the manufacturing process.

The described reinforcement elements 1 are preferably used to manufacture prefabricated concrete components. For example, it is conceivable for the reinforcement element 1 to be used to manufacture a double wall. It is further conceivable for the reinforcement element 1 to be used to manufacture a prefabricated ceiling.

FIG. 2 shows a perspective view of an example embodiment of a production plant 18 for manufacturing the reinforcement element 1. As seen in FIG. 2, the production plant 18 comprises a receiving table 19 that receives the reinforcement element 1. The receiving table 19 can have a level table surface 20. The reinforcement element 1 or its main components 2, 3, 8 can lie on the table surface 20 for processing in the production plant 18.

In another, not depicted embodiment, it is conceivable for the receiving table 19 to have a contoured surface that is specially designed to receive the individual parts of the reinforcement element 1. In addition, it is possible for clamping elements to be arranged on the receiving table 19 that act to hold the reinforcement element 1 or to hold the main components 2, 3, 8 of the reinforcement element 1.

The production plant 18 further has a manipulation device 21 that comprises a first articulated arm robot 22 and a second articulated arm robot 23. A gripping mechanism 24 is arranged on the first articulated arm robot 22 which can grip and manipulate the rebar mats 2, 3 and the rod-shaped spacers 8. A welding unit 25 is arranged on the second articulated arm robot 23 that acts to weld the spacers 8 to the rebar mats 2, 3.

The welding unit 25 can preferably be formed as a resistance welding unit. Alternatively, it is conceivable for the welding unit 25 to be formed to execute arc welding, for example using coated electrodes, or arc welding under protective gas, especially MAG.

It can further be provided for the first articulated arm robot 22 and the second articulated arm robot 23 to each have a guide unit 26 and to be arranged on a linear guide device 27 so as to be displaceable by the guide unit 26. In particular, it can be provided for the linear guide device 27 to have one or more guide rails with which the guide unit 26 interlocks. The guide unit 26 can guide the articulated arm robots in a displaceable manner in a longitudinal direction 28. The longitudinal direction 28 preferably runs parallel to a long side 29 of the receiving table 19.

The guide unit 26 can additionally have a drive unit 30 that can displace the guide unit 26 and therefore the articulated arm robots 22, 23 in the longitudinal direction 28. The drive unit 30 can, for example, be connected to a pinion and interlock with a gear rack arranged on the linear guide device 27.

In an alternative embodiment, it is conceivable for the drive unit 30 not to be arranged on the guide unit 26, but for the drive unit 30 to be arranged on the linear guide device 27 and for the guide unit 26 to be driven by, for example, a traction mechanism like a gear belt.

In yet another embodiment variation, it is also conceivable for the receiving table 19 to be displaceable in the longitudinal direction 28 instead of using a linear guide device 27, and therefore for the complete reinforcement element 1 or its components to be movable in the longitudinal direction 28 to be reachable by the individual articulated arm robots 22, 23, 34, 35.

In yet another embodiment variation, it is also conceivable for the drive unit 30 to be coupled to a ball screw, with the guide unit 26 including a ball screw nut.

The drive unit for displacing the guide unit 26 is not limited to the described variations; every drive unit known to the person skilled in the art can be realised.

The first articulated arm robot 22 with the gripping mechanism 24 is preferably arranged nearest to a first front side 32 of the receiving table 19. The second articulated arm robot 23 with the welding unit 25 is preferably arranged nearest to a second front side 32 of the receiving table 19.

As shown in FIG. 2, it can be provided for a second manipulation device 33 to be formed that has a third articulated arm robot 34 and a fourth articulated arm robot 35. The third articulated arm robot 34 can also receive one of the gripping mechanisms 24 and the fourth articulated arm robot 35 one of the welding units 25. In particular, it can be provided for the second manipulation device 33 with the third articulated arm robot 34 and the fourth articulated arm robot 35 to be a mirror image of the manipulation device 21. The second manipulation device 33 can be arranged on the receiving table 19 on the side across from the first manipulation device 21.

In a first variation of operation of the production plant 18, it is conceivable for the first manipulation device 21 to process the reinforcement element 1 on one half of the receiving table 19 and for the second manipulation device 33 to process the reinforcement element 1 on the second half of the receiving table 19. Alternatively, it is conceivable for all articulated arm robots 22, 23, 34, 35 to be able to approach or reach the complete width 36 of the receiving table 19 and the complete length 37 of the receiving table 19. In such an embodiment variation, the individual tools of the articulated arm robots 22, 23, 34, 35 can work together co-operatively. For example, it is conceivable for a rebar mat 2, 3 to be lifted by both the first articulated arm robot 22 and the third articulated arm robot 34.

The articulated arm robots 22, 23, 34, 35 are preferably formed as six-axis robots, with the linear guide device 27 realising a seventh axis in each case.

As further shown in FIG. 2, it can be provided for a conveying unit 38 to be arranged on the long side 29 of the receiving table 19, which conveying unit 41 acts to feed spacers 8 to the articulated arm robots 22, 34. The conveying unit 38 can, for example, be designed in the form of a circumferential carrying unit, such as a chain, where the chain can have multiple carrying elements 38 that hold the rod-shaped spacers 8. As shown in FIG. 2, such a conveying unit 38 for preparing spacers 8 can be arranged on both long sides 29 of the receiving table 19.

The conveying unit 38 can be loaded with the spacers 8 by a manipulation unit 40 arranged on the first front side 31 of the receiving table 19. In particular, it is conceivable for only one manipulation unit 40 to be designed to load two conveying units 38.

The manipulation unit 40 can, for example, be formed as an articulated arm robot that is equipped with the gripping mechanism 24 and can therefore manipulate the rod-shaped spacers 8.

In a first embodiment variation, it is conceivable for the rod-shaped spacers 8 to be manufactured in an external production plant and fed into the production plant 18 and the production process individually. For example, the spacers 8 can be fed in loose form into a separation station and removed from it by the manipulation unit 40. In such an embodiment variation, it may be necessary for the rod-shaped spacers 8 to have a uniform and identical length.

In an alternative variation, it can be provided for a preparation device 41 to be formed in which the rod-shaped spacers 8 are cut to the required length and supplied to the manipulation unit 40.

The preparation device 41 can, for example, be designed to cut the rod-shaped spacers 8 to length from bar stock and supply them. In another embodiment variation, it can be provided for the raw material for the spacers 8 to be coiled on a roll and to be uncoiled and subsequently cut to length by the preparation device 41.

It can further be provided for the production plant 18 to comprise one or more injection moulding devices 42 by which the protective caps 18 can be moulded onto the rod-shaped spacers 8. Thus it is possible for the rod-shaped spacers 8 to be furnished with the protective cap 17 after being cut to length.

FIG. 3 shows a top view of the example embodiment of the production plant 18 shown in perspective in FIG. 2, with the same reference signs and component names used for the same parts as in the preceding FIGS. 1 and 2. To avoid unnecessary repetition, please refer to the detailed description in the above FIGS. 1 and 2.

In the illustration in FIG. 3, the reinforcement element 1 is laid on the table surface 20 of the receiving table 19 and is processed by the manipulation devices 21, 33.

FIG. 4 shows a side view of the example embodiment of the production plant 18 shown in FIG. 2, with the same reference signs and component names used for the same parts as in the preceding FIGS. 1 to 3. To avoid unnecessary repetition, please refer to the detailed description in the above FIGS. 1 to 3.

FIG. 5 shows a view from the front of the front side 32 of the example embodiment of the production plant 18 from FIG. 2, with the same reference signs and component names used for the same parts as in the preceding FIGS. 1 to 4. To avoid unnecessary repetition, please refer to the detailed description in the above FIGS. 1 to 4.

FIG. 6 shows another example embodiment of the production plant 18 where a view corresponding to the view in FIG. 5 has been chosen and where again the same reference signs and component names are used for the same parts as in the preceding FIGS. 1 to 5. To avoid unnecessary repetition, please refer to the detailed description in the above FIGS. 1 to 5.

As shown in FIG. 6, it can be provided for a lifting unit 43 to be formed that acts to manipulate the reinforcement element 1 or its components. The lifting unit 43 can, for example, take the form of a crane on which a specially designed mat and basket gripper can be arranged. In addition, another preparation device 41 can be formed and arranged near the production plant 18 that serves to manufacture rebar mats 2, 3.

Below, the functioning of the production plant 18 and the individual steps for manufacturing the reinforcement element 1 are described by looking at FIGS. 2-6 together.

In a first step, the first rebar mat 2 is placed on the receiving table 19. It can be provided for the first rebar mat 2 to be laid not directly on the table surface 20 of the receiving table 19 but instead for underlay elements 45 to be arranged on the receiving table 19 and for the first rebar mat 2 to therefore be placed at a certain distance from the table surface 20 of the receiving table 19.

The first rebar mat 2 can be executed in the form of a standard rebar mat that is cut to length. Alternatively, it is conceivable for the first rebar mat 2 to be manufactured out of individual mat rods 6 directly in the preparation device 41 for rebar mats 2, 3.

When the first rebar mat 2 is now placed on the receiving table 19, the orientation or position of the first rebar mat 2 can then be controlled in another step, and it can be provided for this purpose for a sensor unit to be formed on the production plant 18 that can detect the first rebar mat 2 using an optical detection means. The sensor unit can in particular by received by one of the articulated arm robots 22, 23, 34, 35, preferably on the gripping mechanism 24 or on the welding unit 25.

To manipulate the first rebar mat 2, it can be provided for it to be moved by the lifting unit 43 in the production plant 18. Alternatively, it can be provided for the first rebar mat 2 to be positioned in the production plant 18 using the manipulation device 21, in particular using the first articulated arm robot 22.

If the position of the first rebar mat 2 is known, the rod-shaped spacers 8 can be received by the gripping mechanism 24 of the first articulated arm robot 22 or the third articulated arm robot 34 and held to one of the mat rods 6 of the first rebar mat 2.

Depending on the degree of automation, different variations are conceivable for how the rod-shaped spacer 8 can be received by the gripping mechanism 24. For example, in a fully automated production plant 18 it is conceivable for the rod-shaped spacers 8 to be cut to length in the preparation device 41 according to the specifications and taken out of the preparation device 41 by the manipulation unit 40. Subsequently, in another step, the injection moulding device 42 can mould a protective cap 17 on one or both end sections 16 of the spacers 8. In addition, the rod-shaped spacer 8 can be transferred by the manipulation unit 40 to the conveying unit 38, by which it can be conveyed in the longitudinal direction 28 to the transfer position, where it is received by the gripping mechanism 24. The conveying unit 38 can minimise the travel distance of the gripping mechanism 24. This can increase the efficiency of the production plant 18.

As a rule, all plant parts for transporting the rod-shaped spacer 8 to the gripping mechanism 24 can be omitted individually or in groups. For example, it is also conceivable for the gripping mechanism 24 to be manually loaded with the rod-shaped spacers 8 or for the gripping mechanism 24 to pick up the rod-shaped spacers 8 directly from the preparation device 41 or out of a preparation box.

If the rod-shaped spacer 8 is positioned close to a mat rod 6 of the first rebar mat 2, the welding unit 24 can weld the spacer 8 to the mat rod 6. By the repeated the stated steps, multiple rod-shaped spacers 8 can be welded to the first rebar mat 2.

If the rod-shaped spacers 8 are attached to the first rebar mat 2 according to the specifications, the second rebar mat 3 can be positioned at a normal distance 9 to the first rebar mat 2 and the welding unit 25 can weld the rod-shaped spacers 8 to the mat rods 6 of the second rebar mat 3.

There are various options for positioning the second rebar mat 3. For example, the second rebar mat 3 can be held in position by the gripping mechanism 24 of the articulated arm robots 22, 34.

Alternatively, the second rebar mat 3 can be held in position by the lifting head 44 of the lifting unit 43.

In yet another embodiment variation, it is conceivable for support rods 15 to be welded to the mat rods 6 by the articulated arm robots 22, 23, 34, 35 at a certain distance to the first rebar mat 2. These support rods 15 can thereafter serve to allow the second rebar mat 3 to be laid on the support rods 15 and therefore positioned at the correct distance from the first rebar mat 2. The second rebar mat 3 can also be laid on the support rods 15 by the lifting head 44 of the lifting unit 43 or, for example, brought into position by the gripping mechanism 24 of the articulated arm robots 22, 34.

After completion of the welding work for connecting the second rebar mat 3 to the rod-shaped spacers 8, the fully welded reinforcement element 1 can be taken from the receiving table 19 by the lifting unit 43 or by the gripping mechanism 24 and transported away.

FIG. 7 shows a perspective view of a possible embodiment variation of the gripping mechanism 24. As shown in FIG. 7, it can be provided for the gripping mechanism 24 to comprise two gripping heads 46 formed for gripping rod-shaped spacers 8. The gripping heads 46 can each have a first gripping finger 47 and a second gripping finger 48. In addition, an actuator can be formed to close and open the two gripping fingers 47, 48. The actuator 49 can, for example, take the form of a pneumatic cylinder. In addition, an opening sensor 50 can be formed that can detect an open or closed position of the gripping fingers 47, 48.

As shown in FIG. 7, a detection unit 51 can be arranged on the gripping mechanism 24 that can, for example, detect the position of one of the rebar mats 2, 3 or the distance from the gripping mechanism 24 to the receiving table 19. It can further be provided for an additional detection unit to be arranged on the welding gun.

It is further conceivable for the gripping mechanism 24 to have a coupling device 52, which coupling device 52 couples the gripping mechanism 24 to one of the articulated arm robots 22, 23, 34, 35. The coupling device 52 can, for example, be formed as a fast coupling unit so that the gripping mechanism 24 can, for example, be exchanged for a differently formed gripping mechanism 24.

FIG. 8 shows a perspective view of a possible embodiment variation of the two gripping fingers 47, 48. As can easily be seen in FIG. 8, it can be provided for a groove 53 to be formed on the gripping surfaces facing each other parallel to the longitudinal extension of the two gripping fingers. The groove 53 can, for example, have a V-shape. The two V-shaped grooves of the two gripping fingers 47, 48 that face each other make it possible for the rod-shaped spacers 8, which are preferably manufactured from a round material, to be received in a centred and precisely positioned way between the gripping fingers 47, 48. In addition, the V-shaped groove 53 can clamp a variety of spacers 8 with a variety of diameters between the gripping fingers 47, 48. It can further be provided for recesses 54 to be formed in the gripping fingers 47, 48, especially next to the groove 53, through which the gripping fingers 47, 48 can interlock. This makes it possible for the gripping fingers 47, 48 to be closed to a minimum and, for example, for rod-shaped spacers 8 with very small diameters to be clamped in the gripping head 46.

It is further shown in FIG. 8 that another gripping groove 55 can be arranged in the gripping fingers 47, 48 that is placed crosswise to the longitudinal extension of the gripping fingers 47, 48. The additional gripping groove makes it possible, for example, for the individual mat rods 6 of one of the rebar mats 2, 3 to be gripped. If, as shown in FIG. 7, two gripping heads 46 are arranged on the gripping mechanism 24, it is necessary for the additional gripping groove 55 to be arranged at a specific angle in the gripping fingers 47, 48. This makes it possible for a straight mat rod 6 to be gripped using the additional gripping groove 55 of the two neighbouring gripping heads 46.

As further shown in FIG. 8, a depression 56 can be provided in the gripping fingers 47, 48, in particular on the sides facing each other. The depression 56 can in particular be provided as free space to receive the protective cap 17 of the spacer 8.

FIG. 9 shows a side view of the gripping head 46, which is in an open position and is just reaching for the rod-shaped spacer 8. FIG. 9 shows particularly well that the recesses 54 of the two gripping fingers 47, 48 can interlock.

FIG. 10 shows a top view, FIG. 11 a perspective view of an embodiment variation of the conveying unit 38. As shown particularly well in FIGS. 10 and 11, it can be provided for the conveying unit 38 to comprise, for example, a conveying chain 57 on which the individual carrying elements 39 are arranged. In particular, the carrying elements 39 can be attached to a chain element 58 or replace a chain element 58.

The carrying elements 39 can comprise a U-shaped positioning sheet 59, with a positioning groove 60 formed on each of the two opposite legs of the U-shaped positioning sheet 59. A magnet can pull the rod-shaped spacer 8 into the positioning groove 60 so that it is oriented and held in the carrying element 49. It can further be provided for multiple positioning grooves 60 to be formed, with the different positioning grooves 60 formed to receive spacers 8 with different diameters. The positioning grooves 60 can either be V-shaped or preferably have a curvature adapted to the diameter of the particular spacer 8.

As an alternative to this embodiment, it can, for example, be provided for grid elements of an elastic steel or plastic to be formed on the carrying element 39 into which the rod-shaped spacer 8 can be clipped.

As is particularly evident in FIG. 11, it can be provided for the conveying unit 38 to comprise a guide rail 62 into which the conveying chain 57 can be fed. In this way, the conveying unit 38 can reach across the whole length 37 of the receiving table 19, with the position of the carrying elements 39 and therefore of the rod-shaped spacers 8 fixed by the guide rail 62.

FIG. 12 shows a perspective view of a possible embodiment variation of the welding unit 25. As shown in FIG. 12, it can be provided for the welding unit 25 to comprise a coupling device 52 by which it can be coupled to one of the articulated arm robots 22, 23, 34, 35. Like for the gripping mechanism 24, it can be provided for the coupling device 52 to be formed as a quick coupling device.

As is shown particularly well in FIG. 12, it can be provided for the welding unit 25 to be formed as a resistance welding unit. The welding unit 25 can comprise a transformer 63 that transforms the welding current to the required current strength. Because of the high current strengths required for resistance welding, it is necessary for welding current cables 64 to have a high diameter. It is therefore particularly advantageous if the transformer 63 is as close to a welding gun 65 as possible.

As seen in FIG. 12, it can be provided for the welding gun 65 to have a first lever arm 66 and a second lever arm 67 that are connected in a pivot joint 68 and for the welding gun 65 to be opened and closed by an actuator 69. When the welding gun 65 closes, the two welding assemblies 70 act on the two components being welded with a pre-specified or pre-specifiable force. Introducing current allows the two components being welded to subsequently be welded. A welding gun 65 formed in this way is called an X-gun.

It can further be provided for the pivot joint 68 to receive the welding gun 65 such that it can swivel. This means it can be avoided that the elements being welded are displaced or deformed when the welding gun 65 closes, as incorrect positioning of the welding unit 25 can be compensated for. It further makes it possible for the two welding assemblies 70 to exert an equal welding force on the elements being welded.

In a further development of the welding unit 25, it can be provided for the welding unit 25 to comprise a detection unit 71 that can detect an opening width of the welding gun 65. The detection unit 71 is preferably arranged on the welding gun 65 in such a way that the position of the first lever arm 66 and/or the second lever arm 67 is detected. In this way the opening width of the welding gun 65 can be determined. It can in particular be provided for the diameter of the spacer 8 and/or the mat rods 6 to be determined by determining the opening width of the welding gun 65 before the start of the welding process. Using this information, the required current and the required welding time to achieve a certain penetration depth can be calculated. The optimal penetration depth is between about 11% and 13% of the rod diameter. If the penetration depth is less, the strength of the welding may not be sufficient. If the penetration depth is greater, the rod's tensile strength may be weakened.

It can further be provided for the opening width of the welding gun 65 to be determined again after the welding process is finished to check the result of the welding. In particular, it can be provided herein for the control software of the production plant 18 to be designed such that the welding current and/or welding time are adjusted based on the measurements before the welding process and after the end of the welding process and the control software is therefore able to learn. It can further be provided that if the penetration depth detected is too small, the production plant 18 issues an acoustic and/or optical signal to a machine operator and the production process stops.

FIG. 13 shows a possible additional embodiment variation of the welding gun 65 that is formed as a C-gun. In this embodiment variation, the welding assemblies 70 are arranged on a fixed arm 72 and a displaceable arm 73. The displaceable arm 73 can be linearly displaced by an actuator in the direction of the fixed arm 72 or away from it. The linear displacement of the welding assemblies 70 clamps the piece to be welded and allows it to be welded.

FIG. 14 shows another embodiment variation of the welding gun 65. In this embodiment variation, the gripping mechanism 24 is integrated directly into the welding gun 65. Therefore only the first articulated arm robot 22 is needed, on which both the gripping mechanism 24 and the welding gun 65 are arranged. In particular, it can be provided for the gripping mechanism 24 to take the form of a magnet 74 arranged on one of the lever arms 66, 67 in order to hold the rod-shaped spacers 8. The spacers 8 can be fed into the magnet 74 before the welding. During the welding process, the spacers 8 are positioned and welded by the welding gun 65.

FIG. 15 shows a perspective view of the lifting head 44. This figure shows that it can be provided for the lifting head 44 to have multiple lifting hooks 75. The lifting hooks 75 are used to grip the reinforcement element 1 or the rebar mats 2, 3. In particular, the lifting hooks 75 grip the mat rods 6. It can further be provided for the lifting hooks 75 to each be arranged on an actuator 76. This allows the lifting hooks 75 to be moved relative to the lifting head 44, with the individual mat rods 6 being pressed against one or more arresters 77. The actuator 76 can preferably take the form of a pneumatic cylinder that can be displaceable between an extended position and a retracted position. This measure allows the mat rods 6 to be clamped and a secure grip to be ensured on the reinforcement element 1 or the rebar mats 2, 3. In addition, it can be provided for the arresters 77 to have a serrated surface, preventing the rebar mats 2, 3 from slipping.

The lifting hooks 75 and the actuators 76 as well as the arresters 77 can each be arranged in rows on a common hook unit. The hook unit can optionally be arranged to be displaceable on the lifting head 44.

It can further be provided for the lifting head 44 to have a main body 78 on which telescope arms 79 are arranged on one or both broadsides. The telescope arms 79 can preferably be pushed into or pulled out of the main body 78. This makes it possible to vary the length of the lifting head 44.

In a first embodiment variation, it can be provided for the telescope arms 79 to be arranged on both broadsides of the main body 78 and for the telescope arms 79 to be coupled to each other such that they can be adjusted by a shared drive unit and always extended or retracted symmetrically relative to the main body 78.

In another embodiment variation, it can be provided for the telescope arms 79 to each be controlled by their own drive unit and therefore adjusted independently of each other.

In yet another embodiment variation, it can be provided for the telescope arms 79 to be extended and retracted manually.

It can further be provided for one or more lifting cables 80 to be arranged on the main body 78 of the lifting head 44. The lifting cables 80 connect the lifting head 44 to the lifting unit 43. The lifting cables 80 are preferably arranged on the main body 78 such that the lifting head 44 has high stability.

FIG. 16 shows a perspective view of an additional possible embodiment variation of the gripping mechanism 24. As is visible from FIG. 16, it can be provided for the two gripping heads 46 to be arranged opposite each other on the gripping mechanism 24. This is particularly advantageous for avoiding collisions between rods.

FIG. 17 shows another possible embodiment variation of the production plant 18. As shown in FIG. 17, it can be provided for a rod magazine 81 to be formed on which the rod-shaped spacers 8 can be temporarily stored. The rod-shaped spacers 8 can then be taken off the rod magazine 81 and fed into the conveying unit 38 by the manipulation unit 40. It is further conceivable for the rod-shaped spacers 8 to be taken off the rod magazine 81 and fed into the conveying unit 38 by the gripping mechanism 24. The rod magazine 81 can in particular take the form of a rotary table that can turn. The rod magazine 81 can additionally have a separation device 82 into which the rod-shaped spacers 8 can be fed in large quantities and through which the rod-shaped spacers 8 can be brought into their position on the rotary table. It can further be provided for magnets to be arranged on the rotary table to hold the rod-shaped spacers 8. Alternatively, it can be provided for grid devices to be formed to hold the rod-shaped spacers 8.

FIG. 18 shows a perspective view of an example embodiment of the underlay element 45. As can be seen in FIG. 18, it can be provided for the underlay element 45 to have one or more manipulation pegs 83. The manipulation pegs 83 allow the underlay element 45 to be gripped and manipulated by the gripping mechanism 24. This allows the underlay element 45 to be freely positioned on the receiving table 19. This makes it possible for multiple underlay elements 45 to be positioned on the receiving table 19 independent of the grid as needed. The manipulation peg 83 can, for example, take the form of a rod that has a diameter similar to the rod-shaped spacers 8. This measure allows the manipulation peg 83 to be easily gripped by the gripping mechanism 24. In particular, it can be provided for the manipulation peg 83 to be arranged on the top side of the underlay element 45. The top side of the underlay element 45 is the side on which the first rebar mat 2 is placed or that faces away from the table surface 20. One manipulation peg 83 is preferably arranged at each lengthwise end of the underlay element 45.

The example embodiments show possible variations of the production plant 18 for manufacturing the reinforcement element 1; let it be noted at this juncture that the invention is not limited to the specially portrayed variations of embodiments themselves, but that diverse combinations of the individual variations of embodiments are possible and that this possibility of variation falls within the competence of a person active in this technical field based on the teaching regarding technical action provided by this invention.

Furthermore, individual characteristics or combinations of characteristics from the depicted and described various example embodiments can constitute independent inventive or invented solutions.

The aim underlying the independent invented solutions can be taken from the description.

All information regarding ranges of values in this description should be understood to mean that these include any and all partial ranges, e.g. the statement 1 to 10 should be understood to mean that all partial ranges starting from the lower threshold 1 and the upper threshold 10 are included, i.e. all partial ranges begin with a lower threshold of 1 or larger and with an upper threshold of 10 or less, e.g. 1 to 1.7 or 3.2 to 8.1 or 5.5 to 10.

Above all, the individual embodiments shown in FIGS. 1, 2-5, 6, 7-9, 10-11, 12, 13, 14, 15, 16 can form the subject of independent invented solutions. The relevant aims according to the invention and solutions can be found in the detailed descriptions of these figures.

As a matter of form, let it be noted that, to facilitate a better understanding of the design of the production plant 18, it and its components have in places been portrayed to scale.

### LIST OF REFERENCE SIGNS

| | |
|---|---|
| 1 | Reinforcement element |
| 2 | First rebar mat |
| 3 | Second rebar mat |
| 4 | First mat plane |
| 5 | Second mat plane |
| 6 | Mat rod |
| 7 | Junction point |
| 8 | Rod-shaped spacer |
| 9 | Mat planes normal distance |
| 10 | Welding connection |
| 11 | Direction pointing away from the |
| | second rebar mat |
| 12 | First protrusion length |
| 13 | Direction pointing away from the |
| | first rebar mat |
| 14 | Second protrusion length |
| 15 | Support rod |
| 16 | Spacer end section |
| 17 | Protective cap |
| 18 | Production plant |
| 19 | Receiving table |
| 20 | Table surface |
| 21 | Manipulation device |
| 22 | First articulated arm robot |
| 23 | Second articulated arm robot |
| 24 | Gripping mechanism |
| 25 | Welding unit |
| 26 | Guide unit |
| 27 | Linear guide device |
| 28 | Longitudinal direction |
| 29 | Long side |
| 30 | Drive unit |
| 31 | First front side |
| 32 | Second front side |
| 33 | Second manipulation device |
| 34 | Third articulated arm robot |
| 35 | Fourth articulated arm robot |
| 36 | Receiving table width |
| 37 | Receiving table length |
| 38 | Conveying unit |
| 39 | Carrying element |
| 40 | Manipulation unit |
| 41 | Preparation device |
| 42 | Injection moulding device |
| 43 | Lifting unit |
| 44 | Lifting head |
| 45 | Underlay element |
| 46 | Gripping head |
| 47 | First gripping finger |
| 48 | Second gripping finger |
| 49 | Actuator |
| 50 | Opening sensor |
| 51 | Detection unit |
| 52 | Coupling device |
| 53 | Groove |
| 54 | Recess |
| 55 | Additional gripping groove |
| 56 | Depression |
| 57 | Conveying chain |
| 58 | Chain element |
| 59 | Positioning sheet |
| 60 | Positioning groove |
| 61 | Magnet |
| 62 | Guide rail |
| 63 | Transformer |
| 64 | Welding current cable |
| 65 | Welding gun |
| 66 | First lever arm |
| 67 | Second lever arm |
| 68 | Pivot joint |
| 69 | Actuator |
| 70 | Welding assemblies |
| 71 | Detection unit |
| 72 | Fixed arm |
| 73 | Displaceable arm |
| 74 | Magnet |
| 75 | Lifting hook |
| 76 | Actuator |
| 77 | Arrester |
| 78 | Main body |
| 79 | Telescope arm |
| 80 | Lifting cable |
| 81 | Rod magazine |
| 82 | Separation device |
| 83 | Manipulation peg |

1-20. (canceled)

21: A production plant (18) for manufacturing a three-dimensional reinforcement element (1) for a reinforced concrete element, comprising a receiving table (19) for accommodating the reinforcement element (1) and a manipulation device (21) for handling and joining individual parts (2, 3, 8) of the reinforcement element (1), wherein the manipulation device (21) comprises a gripping mechanism (24) for positioning rebar mats (2, 3) and/or spacers (8) of the reinforcement element (1) and a welding unit (25) for welding the spacers (8) to the rebar mats (2, 3), wherein the gripping mechanism (24) is arranged on a first articulated arm robot (22) and the welding unit (25) is arranged on a second articulated arm robot (23).

22: The production plant as disclosed in claim 21, wherein the first (22) and the second articulated arm robots (23) are each arranged on a common linear guide device (27) by a guide unit (26) and are therefore displaceable in the longitudinal direction (28) of the receiving table (19) relative to each other and relative to the receiving table (19).

23: The production plant as disclosed in claim 21, wherein the first (22) and second articulated arm robots (23) are executed as dual arm robots and share a common base unit.

24: The production plant as disclosed in claim 21, wherein a second manipulation device (33) is formed that comprises a third articulated arm robot (34) with an additional gripping mechanism (24) for positioning rebar mats (2, 3) and/or spacers (8) of the reinforcement element (1) and a fourth articulated arm robot (35) with an additional welding unit (25) for substance welding of the spacers (8) to the rebar mats (2, 3), where the second manipulation device (33) is arranged on the side of the receiving table (19) across from the first manipulation device (21).

25: The production plant as disclosed in claim 21, wherein at least one of the articulated arm robots (22, 23, 34, 35) has a coupling device (52) so that it can receive variously designed gripping mechanisms (24) and/or welding units (25).

26: The production plant as disclosed in claim 21, wherein the welding unit (25) is formed as a resistance welding unit.

27: The production plant as disclosed in claim 21, wherein a lifting unit (43), in particular a crane, is formed to manipulate the individual parts (2, 3, 8) of the reinforcement element (1) and/or the entire reinforcement element (1).

28: The production plant as disclosed in claim 21, wherein a preparation device (41) is formed for cutting to length and supplying the spacers (8) and/or rebar mats (2, 3).

29: The production plant as disclosed in claim 21, wherein at least one conveying unit (38) is arranged on a long side (29) of the receiving table (19), with the conveying unit (38) formed to convey spacers (8) to the articulated arm robots (23, 34).

30: The production plant as disclosed in claim 28, wherein the conveying unit (38) is designed in the form of a circumferential carrying unit, in particular a chain, where the carrying unit comprises multiple carrying elements that can each receive a spacer (8).

31: The production plant as disclosed in claim 29, wherein a manipulation unit (40), in particular an additional articulated arm robot, is arranged at the front of the receiving table (19) and designed to load the conveying unit (38) with spacers (8).

32: The production plant as disclosed in claim 21, wherein the gripping mechanism (24) comprises a gripping head (46) that has a first (47) and a second gripping finger (48), where the two gripping fingers (47, 48) each have a V-shaped groove (53) on the side facing each other and where both gripping fingers (47, 48) each have mirror-inverted recesses (54) and therefore interlock with each other.

33: The production plant as disclosed in claim 21, wherein an injection molding device (42) is arranged at the front of the receiving table (19) that is used to mold a protective cap (17) onto at least one end section (16) of the rod-shaped spacer (8).

34: A method for manufacturing a three-dimensional reinforcement element (1), in particular using a production plant (18) as disclosed in claim 21, wherein the method comprises the following steps:
Preparation of a first rebar mat (2) with metallic mat rods (6) welded together at angles at junction points (7), with the first rebar mat (2) positioned on a receiving table (19) and held by it;
Preparation and positioning of rod-shaped spacers (8) across from the mat rods (6) of the first rebar mat (2) using a gripping mechanism (24) of a first articulated arm robot (22);
Welding of the spacers (8) to the mat rods (6) of the first rebar mat (2) using a welding unit (25) arranged on a second articulated arm robot (23), with the mat rods (6) held in position during the welding process by the gripping mechanism (24) of the first articulated arm robot (22);
Preparation and positioning of a second rebar mat (3) at a normal distance (9) from the first rebar mat (2), in particular using the gripping mechanism (24) of the first articulated arm robot (22); and
Welding of the spacers (8) to the mat rods (6) of the second rebar mat (3) using the welding unit (25) arranged on the second articulated arm robot (23).

35: The method for manufacturing a three-dimensional reinforcement element (1) as disclosed in claim 34, wherein the rod-shaped spacers (8) are cut to length in a preparation device (41) before being positioned.

36: The method for manufacturing a three-dimensional reinforcement element (1) as disclosed in claim 34, wherein the rod-shaped spacers (8) are transported to the first articulated arm robot (22) by a conveying unit (38) arranged on the long side (29) of the receiving table (19).

37: The method for manufacturing a three-dimensional reinforcement element (1) as disclosed in claim 36, wherein the rod-shaped spacers (8) are transported to the conveying unit (38) by a manipulation unit (40), in particular an articulated arm robot.

38: The method for manufacturing a three-dimensional reinforcement element (1) as disclosed in claim 34, wherein support rods are attached to the rod-shaped spacers (8) positioned at a certain distance from the first rebar mat (2) before the second rebar mat (3) is positioned in order to create a supporting plane for the second rebar mat (3).

39: The method for manufacturing a three-dimensional reinforcement element (1) as disclosed in claim 34, wherein the diameter of the spacers (8) and/or the mat rods (6) is determined before the welding of the spacers (8) to the mat rods (6) by the welding unit (25).
